(19) United States
(12) Patent Application Publication
(10) Pub. No.: US 2024/0294097 A1
(43) Pub. Date: Sep. 5, 2024

(54) WALK-IN APPARATUS OF VEHICULAR SEAT

(71) Applicant: Hyundai Transys Inc., Seosan-si (KR)

(72) Inventors: Jung Bin LEE, Hwaseong-si (KR); Sang Min KIM, Hwaseong-si (KR); Jun Kyu KIM, Hwaseong-si (KR)

(21) Appl. No.: 18/592,706

(22) Filed: Mar. 1, 2024

(30) Foreign Application Priority Data
Mar. 2, 2023 (KR) 10-2023-0027822

(51) Int. Cl. B60N 2/12

(52) U.S. Cl. CPC B60N 2/12

(57) ABSTRACT

Proposed is a walk-in apparatus provided in a vehicular seat, which includes: an actuator driven by manipulation of a walk-in manipulation unit of a user; a folding unit operated actuated by the actuator and folding a seat back forward; a tilting unit interlocking with the actuation of the folding unit and tilting the seat; and a sliding unit interlocking with the tilting unit and moving the seat forward, in which the tilting unit is tilted by a link pressing member provided in a link connecting the seat to a movable rail.

### CROSS-REFERENCE TO RELATED APPLICATIONS

This application claims priority to and the benefit of Korean Patent Application No. 10-2023-0027822 filed in the Korean Intellectual Property Office on Mar. 2, 2023, the entire contents of which are incorporated herein by reference.

### TECHNICAL FIELD

The present invention relates to a walk-in apparatus of a vehicular seat.

### BACKGROUND ART

In an RV vehicle, or a 3-door type vehicle, some seats have a walk-in function to get on and off rear seat passengers.

The walk-in function of the seat is a function in which when a passenger on a rear seat manipulates a walk-in lever of a front seat in a state in which the passenger is set to sit, a seat rear is folded forward at a predetermined angle as illustrated in FIG. 1, or the seat slides forward by a predetermined distance while the seat rear is tilted as illustrated in FIG. 2, and refers to a function for the passenger on the rear seat to easily get on and off by securing a space between a front seat and the rear seat through the function.

Meanwhile, in the walk-in apparatus, in the related art, a walk-in memory apparatus is proposed which allows the memory module to store a walk-in operation point while being suspended on a walk-in rail when the seat is moved forward by walk-in, if a lock member dragging the memory module is unlocked from the memory module.

However, the walk-in apparatus has a problem in that a locking structure of the memory module and the lock member, and a structure of the memory module for a memory function are also configured to be complex, so cost and weight of the apparatus increase.

### SUMMARY OF THE INVENTION

The present invention is contrived to solve a problem of a background art, and an object to be achieved by the present invention is to provide a walk-in apparatus which has a mechanically simple configuration, and has an improved structure so as to achieve tilting and sliding simultaneously only by button manipulation of a user.

An exemplary embodiment of the present invention provides a walk-in apparatus provided in a vehicular seat, which includes: an actuator driven by manipulation of a walk-in manipulation unit of a user; a folding unit operated actuated by the actuator and folding a seat back forward; a tilting unit interlocking with the actuation of the folding unit and tilting the seat; and a sliding unit interlocking with the tilting unit and moving the seat forward, in which the tilting unit is tilted by a link pressing member provided in a link connecting the seat to a movable rail.

In an exemplary embodiment, the folding unit may include a first lever rotated by a first cable connected to the actuator and releasing a folding restriction means of a recliner provided in the seat back.

Further, the recliner may include a spring providing force of folding the seat back.

In an exemplary embodiment, the tilting unit may include a second lever being in contact with one end of the first lever and rotated by the rotation of the first lever, a second cable pulled by the rotation of the second lever, and a third lever connected to the second cable and rotated when the second cable is pulled, and may be tilted as a rear side of the seat is separated from a latch by the rotation of the third lever.

Further, the link may include a first link of which one end is rotatably coupled to a front side of the movable rail and the other end is coupled to a front lower portion of the seat, and a second link of which one end is rotatably coupled to a rear side of the movable rail and the other end is coupled to a rear lower portion of the seat, and the link pressing member may be provided in any one of the first link or the second link.

In addition, the link pressing member may be a torsion spring provided in at least one of the first link or the second link to tilt the seat.

In an exemplary embodiment, the sliding unit may include a front pressing unit pressing the movable rail to slide to a front which is a driving direction of a vehicle, a sliding restriction means restricting the sliding of the movable rail, a fourth lever interlocking with the first link or the second link, and a fifth lever interlocking with the fourth lever and releasing sliding restriction by the sliding restriction means.

In an exemplary embodiment, the sliding restriction means may include a sixth lever including restriction grooves which are grooves at a predetermined interval in a longitudinal direction of the fixed rail and restriction protrusions inserted and coupled into the restriction grooves, and rotatably coupled to the movable rail, and the sixth lever may rotate in a direction in which the restriction protrusions of the sixth lever depart from the restriction grooves by the rotation of the fifth lever to release the sliding restriction.

Further, the sliding unit may further include a third cable of which one end is coupled to the fourth lever and the other end is coupled to the fifth lever, and the fifth lever may rotate as the third cable is pulled by the rotation of the fourth lever.

According to an exemplary embodiment of the present invention, a walk-in apparatus can be provided, which has a mechanically simple configuration, and has an improved structure so as to achieve tilting and sliding simultaneously only by button manipulation of a user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 are diagrams describing an operation of a walk-in apparatus in the related art.

FIG. 3 is a diagram describing a walk-in apparatus according to an exemplary embodiment of the present invention.

FIG. 4 is a diagram describing a relationship between a fixed rail and a movable rail, and a seat.

FIG. 5 is a diagram describing rotation of a first lever by driving of an actuator and the resulting folding of a seat back.

FIG. 6 is a diagram describing rotation of a second lever and pulling of a second cable by the ration of the first lever.

FIG. 7 is a diagram illustrating a state in which a third lever and a latch are coupled.

FIG. 8 is a diagram illustrating a state in which the third lever and the latch are decoupled by rotation of the third lever.

FIGS. 9 and 10 are diagrams describing that a first link and a second link are rotated and the seat is tilted by a link pressing member.

FIG. 11 is a diagram describing rotation of a fifth lever by a third cable and an operation of a sixth lever which interlocks with the fifth lever.

FIGS. 12 and 13 are diagrams describing that a restriction protrusion departs from a restriction groove while a seventh lever rotates.

FIGS. 14 and 15 are diagrams comparing before and after an operation of the seat using the walk-in apparatus according to the exemplary embodiment.

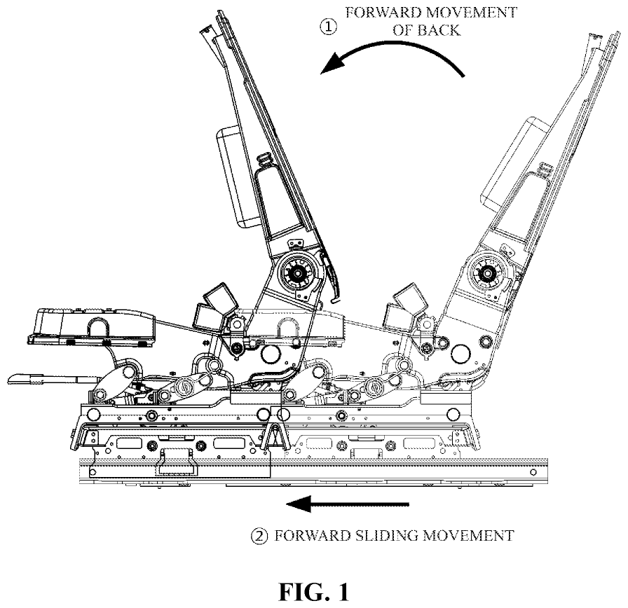

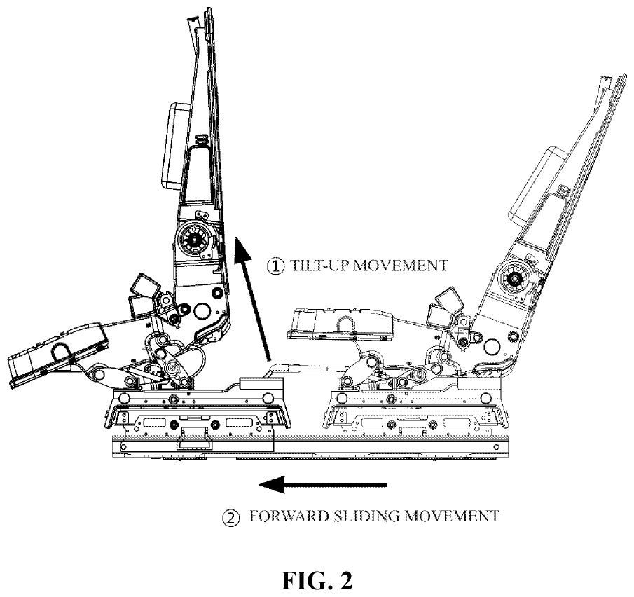

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

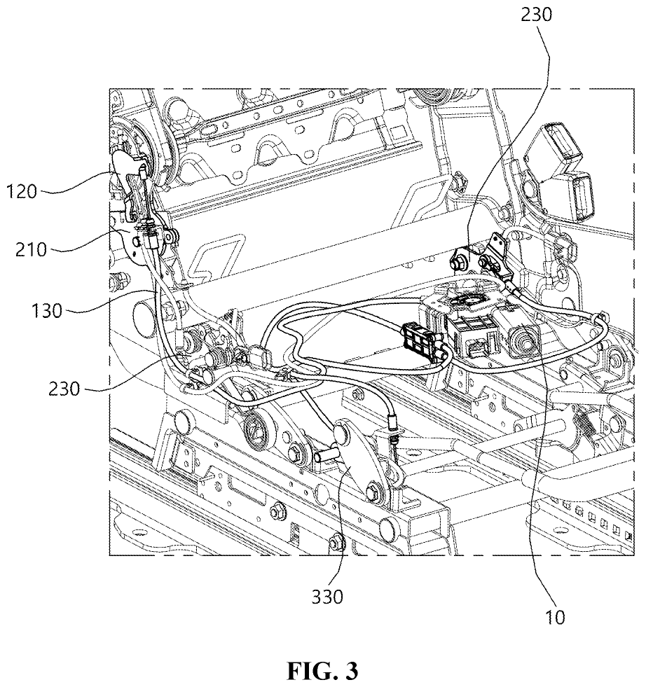

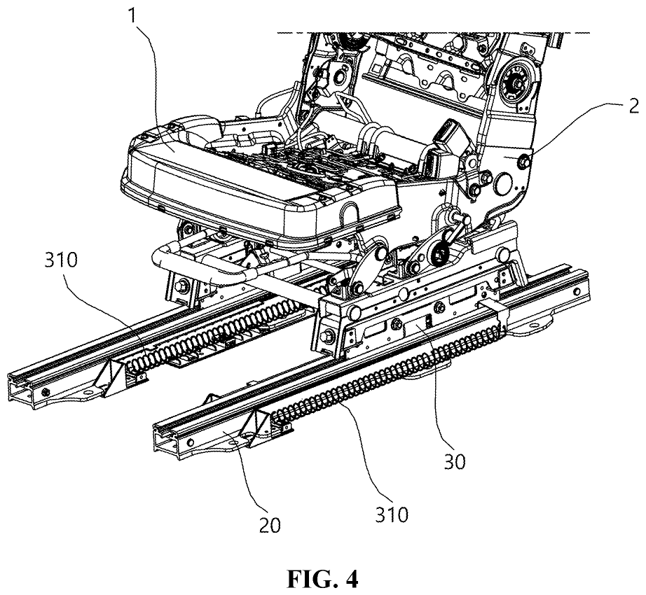

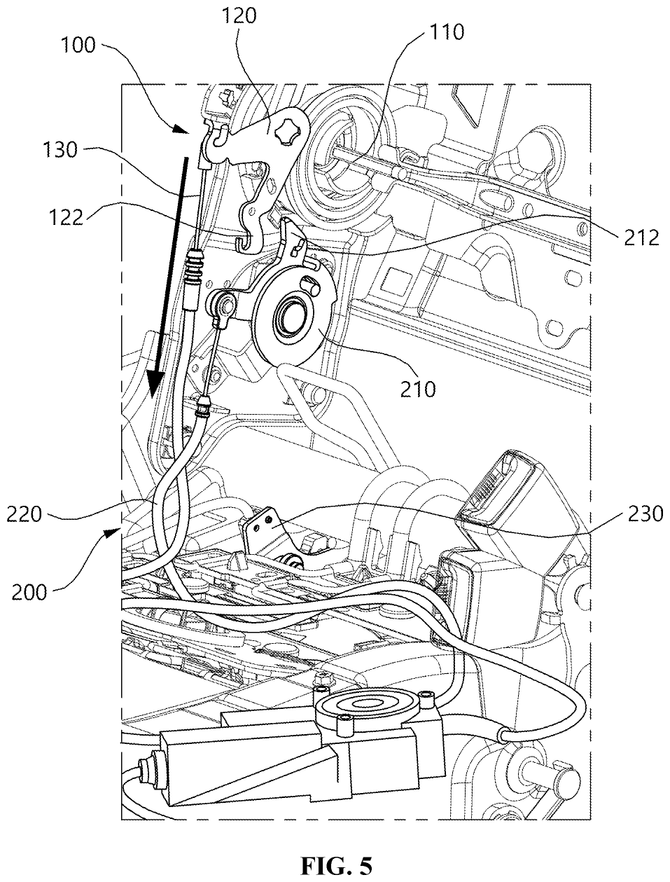

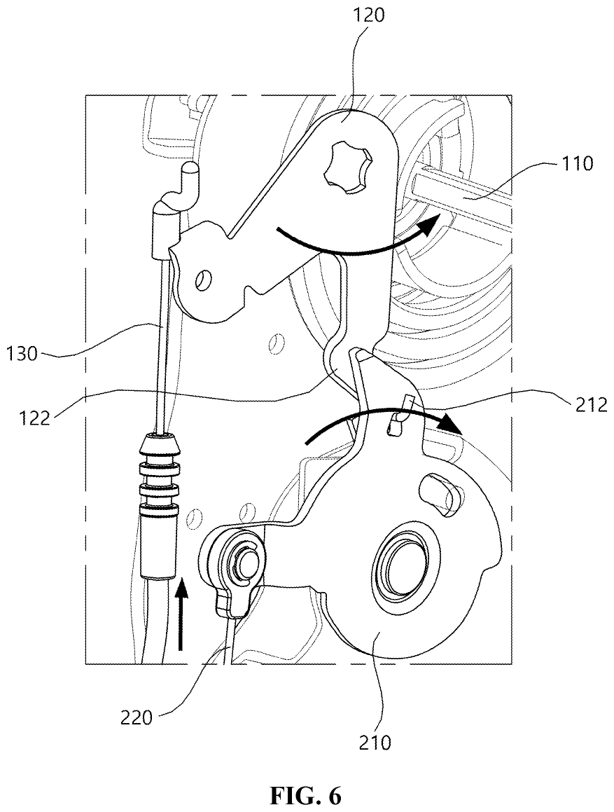

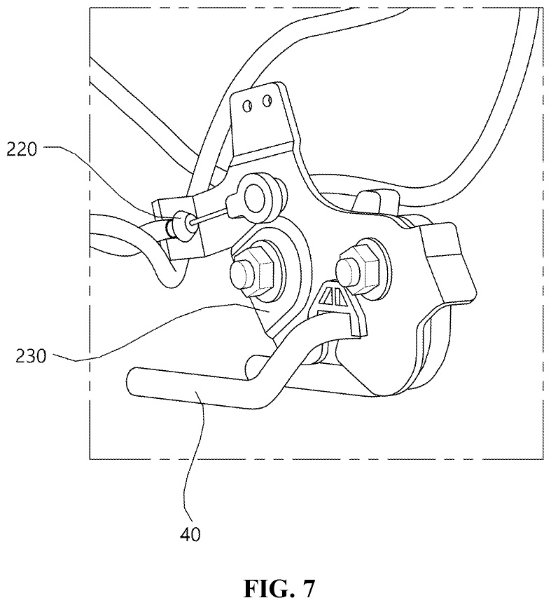

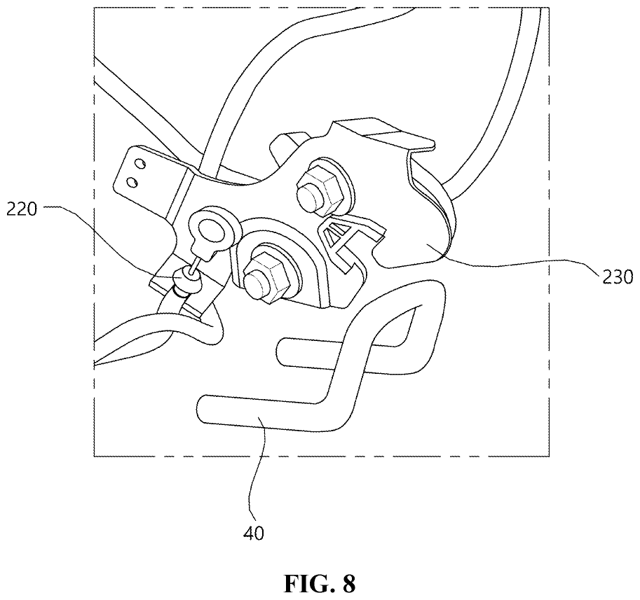

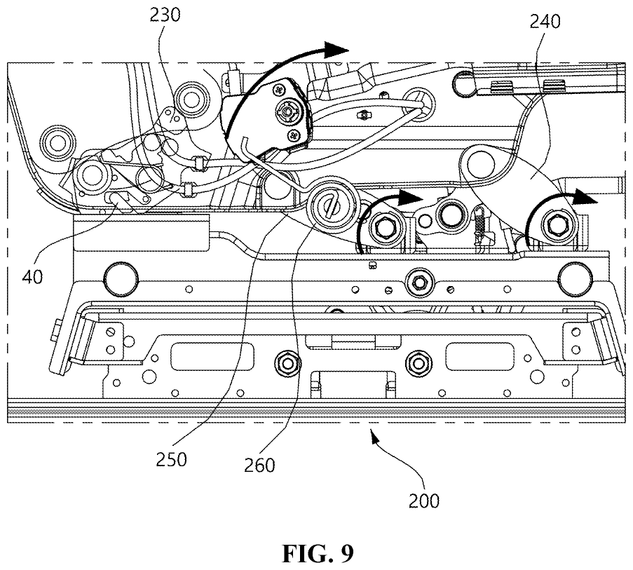

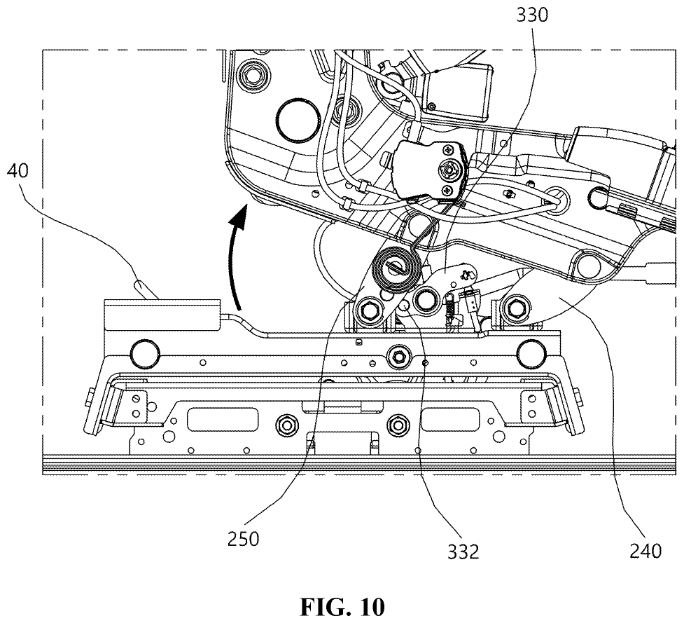

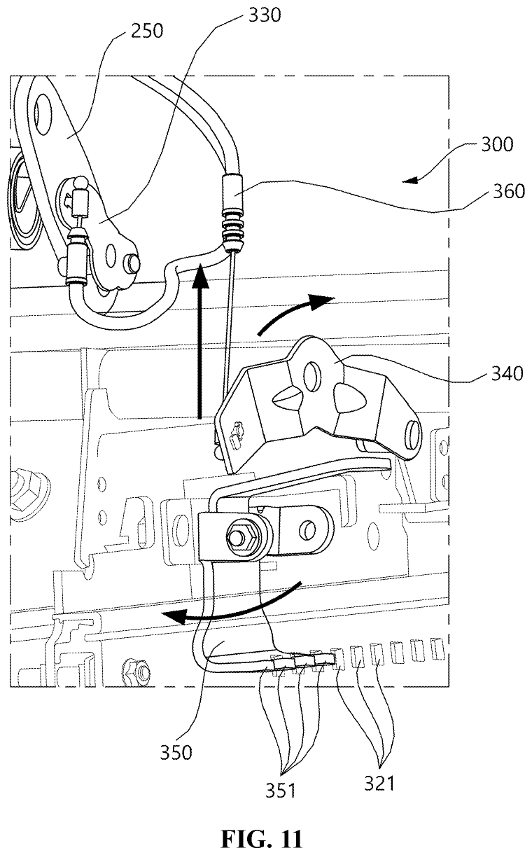

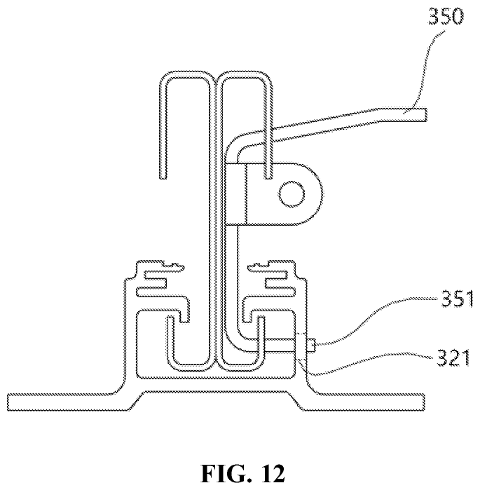

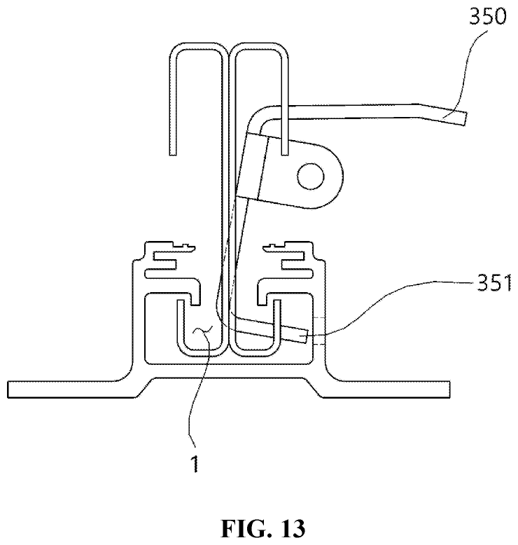

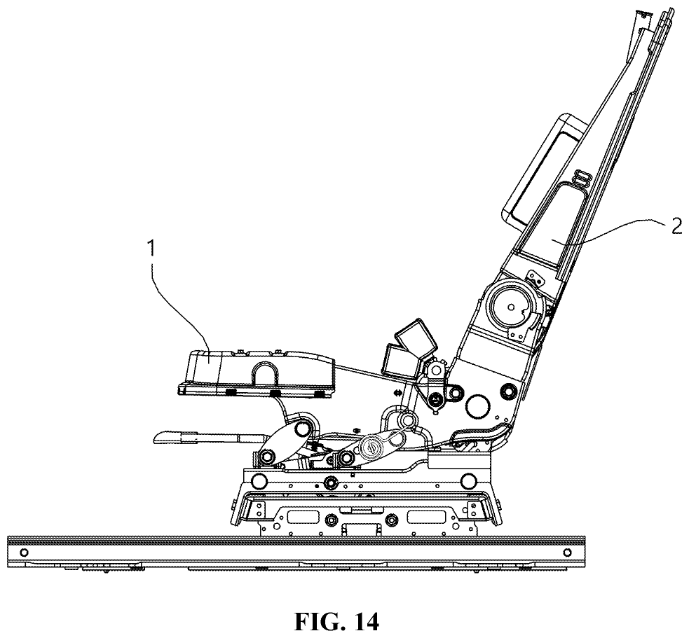

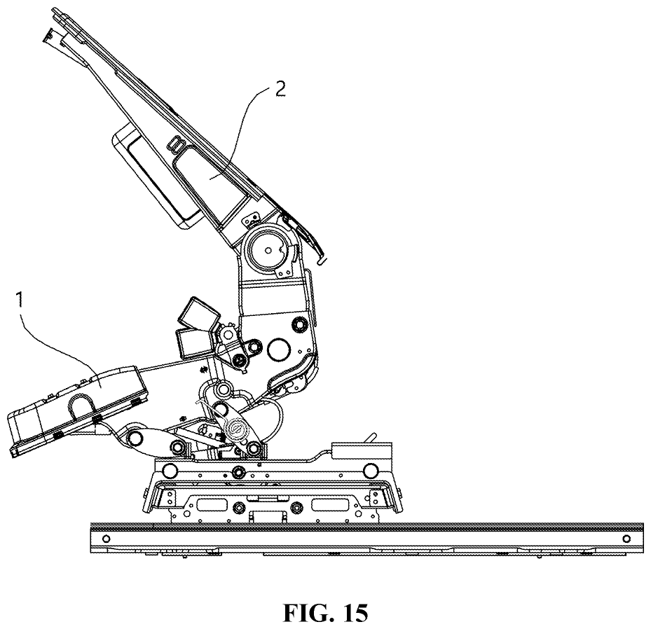

FIG. 3 is a diagram describing a walk-in apparatus according to an exemplary embodiment of the present invention, FIG. 4 is a diagram describing a relationship between a fixed rail and a movable rail, and a seat, FIG. 5 is a diagram describing rotation of a first lever by driving of an actuator and the resulting folding of a seat back, FIG. 6 is a diagram describing rotation of a second lever and pulling of a second cable by the ration of the first lever, FIG. 7 is a diagram illustrating a state in which a third lever and a latch are coupled, FIG. 8 is a diagram illustrating a state in which the third lever and the latch are decoupled by rotation of the third lever, FIGS. 9 and 10 are diagrams describing that a first link and a second link are rotated and the seat is tilted by a link pressing member, FIG. 11 is a diagram describing rotation of a fifth lever by a third cable and an operation of a sixth lever which interlocks with the fifth lever, FIGS. 12 and 13 are diagrams describing that a restriction protrusion departs from a restriction groove while a seventh lever rotates, and FIGS. 14 and 15 are diagrams comparing before and after an operation of the seat using the walk-in apparatus according to the exemplary embodiment.

The walk-in apparatus according to the exemplary embodiment may include an actuator 10, a fixed rail 20, a movable rail 30, a folding unit 100, a tilting unit 200, and a sliding unit 300.

The actuator 10 is driven by manipulation of a walk-in manipulation unit of a user to perform an operation of pulling a first cable 130. As illustrated in FIG. 3, the actuator 10 may be installed below a seat 1. The actuator 10 is operated by mechanically interlocking with the manipulation of the walk-in manipulation unit of the user, but may be electrically operated by the manipulation of the walk-in manipulation unit of the user. In an exemplary embodiment, the walk-in manipulation unit may be configured in a button or lever type, and provided at one side of the seat 1 or a seat back 2. In an exemplary embodiment, the when the actuator 10 is a member which is electrically operated, such as a motor or a solenoid, the walk-in manipulation unit may be a button as a switch for operating the motor or solenoid.

Due to characteristics of a cable, force of pulling any one to the other one is transferred, but the force is not transferred even though the cable is pushed from any one side. A first cable 130, a second cable 220, and a third cable 360 to be described below are cables having the characteristics.

The walk-in manipulation unit for operating the actuator 10 is not illustrated, and may be installed on the seat 1 or the seat back 2, and an installation location may be determined by considering the accessibility of a vehicle user. In this case, the seat 1 is a part which supports a hip when a vehicle user sits, and the seat back 2 is a backrest.

As illustrated in FIG. 4, one pair of fixed rails 20 as rails which are fixed to a floor of a vehicle are provided, and one pair of fixed rails 20 are disposed to be in parallel to each other. A restriction groove 321 is installed in the fixed rail 20, which will be described below.

As illustrated in FIG. 4, the movable rail 30 is coupled to the seat 1 and moved forward and backward along the fixed rail 20 jointly with the seat 1. Hereinafter, a front refers to a forward direction of the vehicle and a rear means a backward direction of the vehicle.

The folding unit 100 as a component for folding the seat back 2 forward may include a recliner 110, a first lever 120, and the first cable 130.

The recliner 110 is a member which adjusts an angle of the seat back 2. The recliner 110 may include a spring, and the seat back 2 may be folded forward by elastic force of the spring provided in the recliner 110. The folding of the seat back 2 is restricted by a folding restriction means (not illustrated), and when the first lever 120 releases the restriction by the folding restriction means, the seat back 2 is folded forward by the spring provided in the recliner 110. The recliner 110 and the folding restriction means as components which restrict the folding of the seat back 2 may adopt a known means, so an additional description will be omitted.

As illustrated in FIG. 5, the first lever 120 may be rotatably provided near the recliner 10, and when the actuator 10 pulls the first cable 130, the folding restriction of the seat back 2 by the folding restriction means is released while the first lever 120 is rotated, and rotational torque by the spring the recliner 110 is transferred to the seat back 2, which enables the seat back 2 to be folded forward.

The tilting unit 200 is a component that performs an operation of lifting a rear side of the seat 1 up, and the seat 1 may be rotated so that a rear side is moved up rather than a front side by actuating the tilting unit 200.

Referring to FIGS. 5 and 9, the tilting unit 200 may include a second lever 210, a second cable 220, a latch 40, a third lever 230, a first link 240, a second link 250, and a link pressing member 260. In an exemplary embodiment, each one of the third lever 230, the latch 40, a fourth lever 240, the first link 240, the second link 250, and the link pressing member 260 may be installed at each of both sides of the seat 1.

Referring to FIGS. 5 and 6, the second lever 210 is rotatably coupled to a lower portion of the first lever 120, and interlocks with the first lever 120. In an exemplary embodiment, one end portion 122 of the first lever 120 and one end portion 212 of the second lever 210 are in contact with each other, so the end 122 of the first lever may transfer rotation driving force to the end 212 of the second lever 210 when the first lever 120 rotates. Interlocking means that when any one component of two components moves or rotates, the other component also moves or rotates jointly, and is described below.

Meanwhile, in FIG. 6, it is illustrated that the second lever 210 rotates in an opposite direction to the first lever, and such a configuration is to conveniently connect the second lever 210 and the second cable 220, and the second lever 210 should not particularly rotate in the opposite direction to the first lever 120, and rotational directions of the first lever 120 and the second lever 210 may also be the same as each other.

The second cable 220 is a cable in which one end is coupled to the second lever 210, and is pulled when the second lever 210 rotates. Referring to FIGS. 3, 7, and 8, the other end of the second cable 220 is coupled to the third lever 230. When the third lever 230 is provided at each of a left side and a right side of the seat, two third levers 230 may be provided each of the left side and the right side, and the other end of the second cable 220 may be branched into two in order to operate the third levers 230 at the left side and the right side.

The latch 40 as a component for fixing the rear side of the seat 1 may be configured in a state in which both ends are fixed to the lower portion (e.g., an upper end of the movable rail 30) of the seat 1 as a component similar to a bent “C” shape. A pair of latches 40 may be provided at the left and right sides of the seat 1.

The third lever 230 as a component rotatably coupled to the lower portion of the seat 1 is connected to the other end of the second cable 220, and rotates when the second cable 220 is pulled.

The third lever 230 maintains a state of being caught on the latch 40 as illustrated in FIG. 7, and when the second cable 220 is pulled, the third lever 230 is separated from the latch 40 as illustrated in FIG. 8.

One end of the first link 230 is coupled to a front side of the movable rail 30, and the other end is coupled to the front side of the seat 1. When the second link 250 rotates by the link pressing member 260, the first link 230 tilts the seat 1 jointly with the second link 250.

One end of the second link 250 is coupled to a rear side of the movable rail 30, and the other end is coupled to a rear side of the seat 1, and the rear side of the seat 1 is lifted up while one end coupled to the movable rail 30 rotates on an axis by the link pressing member 260. To this end, the second link 250 may be formed to be longer than the first link 240.

The link pressing member 260 is a component that presses the first link 240 or the second link 250 in a direction in which the first link 240 and the second link 250 lift up the rear side of the seat 1, and in the exemplary embodiment, it is exemplified that the link pressing member 260 is installed to press the second link 250. As the link pressing member 260, a torsion spring may be used. Referring to FIG. 9, the link pressing member 260 applies force to the link 250 so that the second link 250 rotates in a clockwise direction, and the rear side of the seat 1 is lifted up and the seat 1 is tilted.

FIG. 9 illustrates a state before the seat 1 is tilted as in a state illustrated in FIG. 14 as a state before the first link 240 and the second link 250 rotate, and FIG. 10 illustrates a state in which the seat 1 is tilted as illustrated in FIG. 15 as a state in which the first link 240 and the second link 250 rotate by the link pressing member 260.

The sliding unit 300, which is to simultaneously slide the seat 1 and the seat back 2 forward, includes a forward pressing unit 310, a sliding restriction means, the fourth lever 330, the fifth lever 340, and the third cable 360.

The front pressing unit 310 as a component that presses the movable rail 30 coupled to the seat 1 to slide forward may adopt a coil spring in which one end is fixed to the fixed rail 20 and the other end is fixed to the movable rail 30 as illustrated in FIG. 4. As illustrated in FIG. 14, the front pressing unit 310 is stretched (elastically transformed) before the seat 1 slides.

The sliding restriction means as a component that restricts sliding of the movable rail 30 includes restriction grooves 321 which are grooves formed in the fixed rail 20 at a predetermined interval in a longitudinal direction of the fixed rail, and a sixth lever 350.

As illustrated in FIG. 4, the restriction groove 321 may also be manufactured in the form of a through-hole.

The sixth lever 350 includes a restriction protrusion 351 inserted and coupled into the restriction groove 321. There may be several restriction protrusions 351.

The fourth lever 330 interlocks with the first link 240 or the second link 250. In an exemplary embodiment, referring to FIG. 10, the fourth lever 330 is provided at the upper portion of the movable rail 20, and when the seat 1 is tilted as the first link 240 and the second link 250 rotate in the clockwise direction in FIG. 10, the fourth lever 330 is configured to rotate as an operation protrusion 332 is pressed by the second link 250. In the exemplary embodiment of the present invention, the fourth lever 330 is also enabled to be rotated by the rotation of the first link 240, of course.

The fifth lever 340 releases restriction of sliding by the sliding restriction means by interlocking with the fourth lever 330. Referring to FIG. 11, the fourth lever 330 is connected to the fifth lever 340 by the third cable 360, and while the fourth lever 330 rotates, the third cable 360 is pulled to rotate the fifth lever 340.

When the fifth lever 340 rotates, the sixth lever 350 rotates in a direction in which the restriction protrusion 351 of the sixth lever 350 departs from the restriction groove 321. In FIG. 12, a state in which the restriction protrusion 351 is inserted into the restriction groove 321 is illustrated, and in FIG. 3, a state in which the fifth lever 350 rotates, and the restriction protrusion 351 departs from the restriction groove 321 is illustrated.

When the restriction protrusion 351 departs from the restriction groove 321, the movable rail 30 and the seat 1 slide forward by elastic restoration force of the coil spring.

Meanwhile, the fourth lever 330 and the fifth lever 340 may also be configured to directly interlock with each other, and the reason is that because the fifth lever 340 is installed in contact with the fixed rail 20, and the fourth lever 330 is installed at the movable rail 30 side, the fourth lever 330 and the fifth lever 340 interlocking by the third cable 360 is more advantageous than the fourth lever 330 and the fifth lever 340 directly interlocking with each other.

Hereinafter, by describing the method for driving the seat 1 and the seat back 2 by the walk-in apparatus according to the above-described configuration, a function, an action, and an effect each configuration described will be described.

In order for the user of the vehicle to drive the seat 1 and the seat back 2 from the state illustrated in FIG. 12 to the state illustrated in FIG. 13 boarding, the walk-in manipulation unit is actuated to drive the actuator 10. The actuator 10 pulls the first cable 130 to rotate the first lever 120, and the restriction of the folding restriction means is released while the first lever 120 rotates, and as a result, the recliner 110 folds the seat back. As described above, since the recliner 110 may adopt a known component, a description of a folding mechanism by the recliner 110 will be omitted.

When the first lever 120 rotates, the second lever 210 interlocks, and when the second cable 220 is pulled by the second lever 210, the third lever 230 connected to the second cable 220 rotates.

When the lever 230 departs from the latch 40, and restriction of the third lever 230 and the latch 40 is released, the seat 1 is tilted while the first link 240 and the second link 250 rotate by the elastic restoration force of the torsion spring which is the link pressing member 260.

In the process in which the seat 1 is tilted, the first link 240 and the second link 250 rotate, and when the second link 250 rotates, the fourth lever 330 rotates jointly.

When the fourth lever 330 rotates, the fifth lever 340 rotates while the third cable 360 is pulled (a direction in which the third cable 360 is pulled is marked with an upward arrow of FIG. 11). When the fifth lever 340 rotates, the restriction protrusion 351 departs from the restriction groove 321 while the sixth lever 350 interlocks and rotates (a rotational direction of the sixth lever 350 is marked with a downward semicircular arrow of FIG. 11).

When the restriction protrusion 351 departs from the restriction groove 321, the seat 1 slides forward by the elastic restoration force of the coil spring which is the front pressing unit 310, and becomes the state illustrated in FIG. 13.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A walk-in apparatus provided in a vehicle seat, comprising:
an actuator configured to be driven by manipulation of a walk-in manipulation unit;
a folding unit configured to be actuated by the actuator to fold a seat back forward;
a tilting unit interlocking with the actuation of the folding unit and configured to tilt the vehicle seat; and
a sliding unit interlocking with the tilting unit and configured to move the vehicle seat forward,
wherein the tilting unit is configured to be tilted by a link pressing member provided in a link connecting the vehicle seat to a movable rail.

2. The walk-in apparatus of claim 1, wherein the folding unit includes a first lever configured to be rotated by a first cable connected to the actuator and configured to release a folding restriction means of a recliner provided in the seat back.

3. The walk-in apparatus of claim 2, wherein the recliner includes a spring providing force for folding the seat back.

4. The walk-in apparatus of claim 2, wherein the tilting unit includes a second lever being in contact with one end of the first lever and configured to be rotated by the rotation of the first lever, a second cable configured to be pulled by the rotation of the second lever, and a third lever connected to the second cable and configured to be rotated when the second cable is pulled, and wherein the tilting unit is tilted as a rear side of the vehicle seat is separated from a latch by the rotation of the third lever.

5. The walk-in apparatus of claim 4, wherein the link includes a first link having one end rotatably coupled to a front side of the movable rail and another end coupled to a front lower portion of the vehicle seat, and a second link having one end rotatably coupled to a rear side of the movable rail and another end coupled to a rear lower portion of the vehicle seat, and
wherein the link pressing member is provided in at least one of the first link or the second link.

6. The walk-in apparatus of claim 5, wherein the link pressing member is a torsion spring provided in at least one of the first link or the second link to tilt the vehicle seat.

7. The walk-in apparatus of claim 5, wherein the sliding unit includes a front pressing unit pressing the movable rail to slide to a front which is a driving direction of a vehicle, a sliding restriction means restricting the sliding of the movable rail, a fourth lever interlocking with the first link or the second link, and a fifth lever interlocking with the fourth lever and releasing sliding restriction by the sliding restriction means.

8. The walk-in apparatus of claim 7, wherein the sliding restriction means includes a sixth lever including restriction grooves which are grooves at a predetermined interval in a longitudinal direction of a fixed rail and restriction protrusions inserted and coupled into the restriction grooves, and rotatably coupled to the movable rail, and
wherein the sixth lever is configured to rotate in a direction in which the restriction protrusions of the sixth lever depart from the restriction grooves by the rotation of the fifth lever to release the sliding restriction.

9. The walk-in apparatus of claim 7, further comprising:
a third cable having one end coupled to the fourth lever and another end coupled to the fifth lever,
wherein the fifth lever is configured to rotate as the third cable is pulled by the rotation of the fourth lever.
